(19) United States
(12) Patent Application Publication
(10) Pub. No.: US 2010/0229462 A1
(43) Pub. Date: Sep. 16, 2010

(54) Degradable and Compostable Plastic Films for Agriculture

(75) Inventor: Radrigo A. Garcia, Montgomery, TX (US)

Correspondence Address: The Hanf Law Firm PLLC;7845 Colony Road, Suite C4, Box 158, Charlotte, NC, 28226, US

(73) Assignee: CEROWA, LP, Conroe, TX (US)

(21) Appl. No.: 12/787,716

(22) Filed: May 26, 2010

(51) Int. Cl. A01G 13/02; B29C 49/04

(52) U.S. Cl. 47/9; 264/510

(57) ABSTRACT

A method is taught for increase crop yield and weight per acre comprising the steps of providing a degradable mulch film, then laying the degradable mulch film over a cleared field, and covering a portion of the degradable mulch film with soil. The mulch film is made up a below ground degradable film (B) an above ground degradable film (A), film B is co-extruded with film A and another film B to have a BAB structure where the films B and film A have a single layer feel. Film B is a plastic resin treated with an acid and having an additive that supplies a source of oxygen, and a metal stearate. Film A is a plastic resin an additive for aiding decomposition and an additive to retard decomposition.

### BACKGROUND OF THE INVENTION

Plastic film products have penetrated every sector of the agriculture market in the United States and throughout the world. One of the greatest uses of agricultural films is specifically the one used for mulching. In some cases though, there can be some very serious environmental problems once the film usage is completed. However, these mulching films are necessary in today's “plasticulture”. These films provide a local greenhouse affect by raising the soil temperature of the area covered. The humidity of the soil is well maintained to such level that plant seed germination and root growth is greatly enhanced.

In addition, there is a great savings in water usage since the mulch film prevents evaporation of the water. Another benefit is that chemicals such as fertilizers, pesticides, and herbicides are more easily available to the plants or seeds when protected by the mulch films. These films also greatly reduce weeds that would otherwise fight the intended crop for water and soil nutrients.

However, these mulching films despite all the benefits are causing grave disposal problems to farmers. Removal of these films is necessary because a residual film hampers the next cultivating crop for the farm operations. The previous film suffocates the next crop's root system and presents a great problem for the farm equipment. Therefore, the removal of these films is a necessity and done at a very high price. Burning of the film is severally restricted in most localities especially in the US when dealing with the EPA and since the films may contain residual pesticides and herbicides, burning is definitely out of the question. Exporting these residual films containing dirt, pesticides, and herbicides to China is no longer a valid option. Land filling is expensive and the films trap air which takes up more space. Therefore disposing of these films in a landfill this is not a viable option either.

In most cases the residual film is gathered and collected in a large pile to slowly degrade with time. This option has some inherent problems since pieces of the film can be carried by the wind and in turn, contaminating the landscape and other farmer's land, which can lead to legal issues.

In response, Cerowna LP has developed and designed a controlled photo, chemical, and thermal degradable film system which can incorporate bio degradable technology that addresses all of the above

### SUMMARY OF THE INVENTION

A method is taught for increase crop yield and weight per acre comprising the steps of providing a degradable mulch film, then laying the degradable mulch film over a cleared field, and covering a portion of the degradable mulch film with soil. The mulch film is made up a below ground degradable film (B) and an above ground degradable film (A), film B is co-extruded with film A and another film B to have a BAB structure where the films B and film A have a single layer feel. Film B is a plastic resin treated with an acid and having an additive that supplies a source of oxygen, and a metal stearate. Film A is a plastic resin an additive for aiding decomposition and an additive to retard decomposition.

### DESCRIPTION OF THE DRAWINGS

For the purpose of illustrating the invention, there is shown in the drawings a form that is presently preferred; it being understood, however, that this invention is not limited to the precise arrangements and instrumentalities shown.

FIG. 1 is a top plan view of a mulch film according to the instant invention.

FIG. 2 is a cross sectional view of the mulch film shown in FIG. 1.

FIG. 3 is a cross sectional view of another embodiment the mulch film.

### DETAILED DESCRIPTION OF THE INVENTION

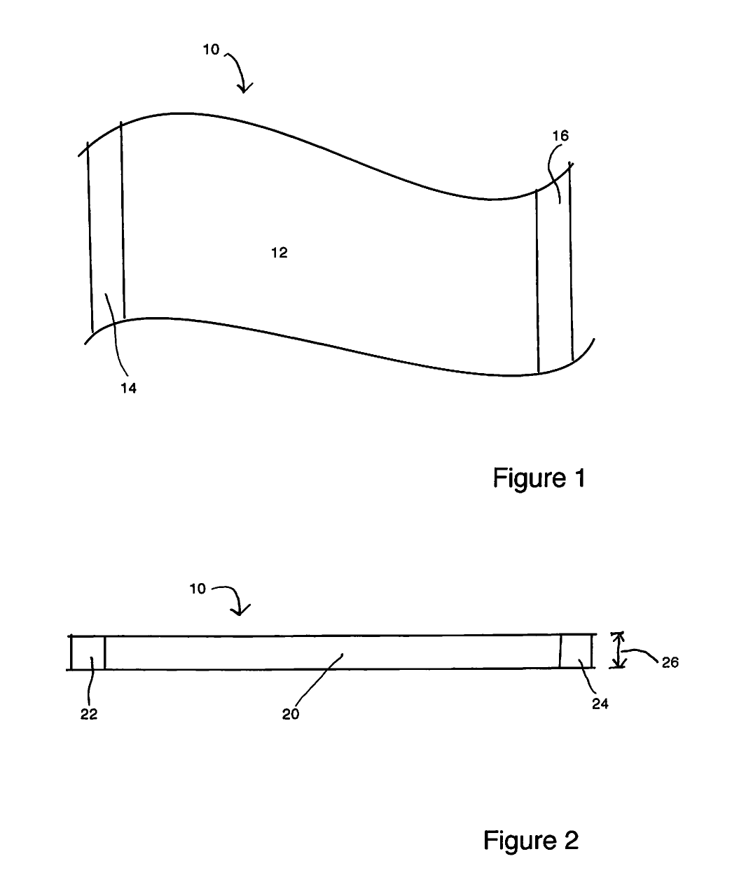

The invention is a method for increase crop yield and weight per acre by providing a degradable mulch film comprised of a below ground degradable film (B) and an above ground degradable film (A). This degradable mulch film 10, FIG. 1 is made by co-extrusion of film B 14, with film A 12, and another film B 16, so that the resulting mulch film 10 has a BAB structure yet the films have a single layer feel. By a single layer feel film A, FIG. 2, 20, and films B 22, 24, have a very similar molecular weight and a very similar thickness 26 so that the entire film can be treated as a homogeneous film. This degradable mulch film is then laid over a cleared field and the below ground degradable film B is covered with soil. Then the degradable mulch film is allowed to biodegrade both above and below the ground.

Film A is made from a plastic resin and having an additive for aiding decomposition and an additive for promoting decomposition.

The plastic resin of film A can be any number of resins including: polypropylene (PP), as a homopolymer or a copolymer as well as syndiotactic PP; polyethylene (PE), including low density PE (LDPE), linear low density PE (LLDPE); condensation polymers such as polybutylene terephthalate (PBT), polyethylene terephthalate (PET), polycarbonate (PC), PE/LDPE blends, PE/masterblends and combinations thereof. The plastic resin makes up from 99.96% to 90% by weight of the above ground resin A. The additive for aiding decomposition is a metal prodegradant. Examples of metal prodegradents include stearates such as cobalt, cerium, iron, manganese, zirconium, nickel and combinations thereof. The additive for aiding decomposition makes up from 0.02% to 5% by weight of the above ground resin A. The additive to retard decomposition is an additive can be an UV stabilizer, metal oxides, primary and secondary antioxidants like butylated hydroxytoluene (BHT) or lonol and Irganox 1010, Irganox 1076, Irgafos 168, Sandostab PEPQ. The additive to retard decomposition makes up from 0.02% to 5% by weight of the above ground resin A.

Film B is made from a natural resin or a plastic resin, which is treated with an acid and a source of oxygen and a metal stearate.

The plastic resin of film B is a resin can be any number of resins including: polypropylene (PP), as a homopolymer or a copolymer as well as syndiotactic PP; polyethylene (PE), including low density PE (LDPE), linear low density PE (LLDPE); condensation polymers such as polybutylene terephthalate (PBT), polyethylene terephthalate (PET), polycarbonate (PC). This resin can also be a bio resin such as polylactic acid (PLA), polycaprotone, mater-B or other bio-resins that meet the ASTM 6400 composting requirements and combinations of these resins thereof. If a bio-resin is used that meet the ASTM 6400 composting requirements it is not necessary to add an acid and a source of oxygen and a metal stearate. However one or more of these additives could be added to help in the decomposition process. The plastic resin or bio-resin makes up from 98.98% to 75% by weight of the below ground resin B. The acid, which the plastic resin is treated with, can include but is not limited to: acrylic acid, methacylic acid, maleic anhydride, vinyl acetate, ethyl acetate, citric acid and combinations thereof. This acid can be added in a range of 2% to 20% by weight. Note that the polymer may also include an acid polymer examples are ethylene ethyl acetate (EEA), ethylene maleic anhydride copolymer (EMA), ethylene vinyl acetate copolymer (EVA). An example of such a polymer is Nucrel from DuPont 1202 HC with 11.5% by weight of methacylic acid in a polyethylene. The additive for aiding decomposition is a metal prodegradant. Examples of metal prodegradents include stearates such as cobalt, cerium, iron, manganese, zirconium, nickel and combinations thereof. The additive for aiding decomposition makes up from 0.02% to 5% by weight of the below ground resin B. The additive that is a source of oxygen can be a pigment that contains oxygen, an oxidizer or combinations thereof. This is not limited to either organic or inorganic pigments. An example of an inorganic pigment, which contains oxygen is iron oxide, and example of a synthetic pigment is syn-oxHB-1053 Black from the Hoover Color Corporation, and an example of an oxidizer is potassium permanganate. The additive that is a source of oxygen makes up from 1% to 40% by weight of the above ground resin B.

This mulch film is laid in a farmer's or grower's field as long sheets, with most of the mulch film positioned above ground, the above ground degradable film A, FIG. 1, 12 then the mulch film 10 is anchored on the outer sides, where the below ground degradable film B 14, 16, is either tucked below ground or covered with dirt or soil. The application of this mulch film will increase crop yield and weight per acre in the growing of vine type and other crops. Examples of these crops include but are not limited to watermelons, melons, cucumbers, tomatoes, peppers, okra, beans, squash and sweet corn.

This unique mulch film allows for a ground covering for a specified growing season but then also degrades at the desired time so that it does not have to be taken up, and can be plowed back into the field where it will finish degrading. As it is made up from two materials the mulch film is then capable of decomposing in both an above ground and a below ground environment. The above ground film has the benefit of oxygen in the air as well as sunlight, which provides ultraviolet rays and heat energy to aid in the decomposition. Therefore the degradation method of the above ground degradable film is a combination of an oxo-degradation, thermal degradation, ultraviolet degradation. Below the ground the portion of the mulch, which is covered by soil does not have ready access to oxygen or ultraviolet rays, and must relay on heat energy, micro organisms, fungi and the chemical composition of the below ground resin to supply the needed elements to biodegrade. The below ground degradation is a combination of thermal degradation, chemical degradation and biodegration.

The mulch film can be distributed in roll form so that it can be unrolled into long sheets on the field. The plastic used will not sticking to itself. This non-stick function makes it easy to unroll the mulch film right to the core. The rolls can be made in any length, but rolls that cover 4,000, 6,000 and 8,000 feet provide the benefit of matching farm acreage and convention methods of coverage calculations. These lengths also complement lengths of other products used in fields including drip-tape coils. In addition these lengths minimize the changing of rolls to reduce labor cost for handling shorter rolls. The roll can be configured to work on layer equipment manufactured by Kenco, Rainflo and JGB and on home made layers with similar specifications. These pieces of equipment generally use 48 inch, 52 inch and 60 inch widths. Therefore the width of the rolls of degradable mulch film can come in these width as well as any other widths that might be demanded by the growers or that is found useful. There is usually a three (3) inch core at the center of the roll, and the diameter and weight of the rolls must be compatible with the capacity of the equipment. However the width of the core can be altered or modified so that it might work on a large variety of layer equipment.

The mulch roll has a special manufacturing process that the roll is configured with the middle portion of the width of the roll is made of an above ground degradable film A, FIG. 1, 12, and on either side is a is a below ground degradable film B, 14, 16. These two different types of films appear, feel and act as one when positioning the roll on the layer equipment. The roll has no bump or change in diameter where the two types of film abut or adjoin. This is due to the mulch film 10, FIG. 2, having the same thickness 26 for the above ground film 20 and the below ground sections 22, 24.

For shipping the roll of mulch film has an outer wrap around the product to maximize storage life of the product and to protect the outer portion of the roll and prevent pre-mature degradation. For best results in using the mulch film it is important to keep the roll in the outer wrap and store it in a cool, dry area, out of sunlight until application of the mulch roll. Care should be taken with the roll to prevent denting. Once the wrap is opened the laying of the roll and planting through the above ground degradable film should be performed within a limited time. When applying the mulch film roll it is important to use the clutch properly on the tractor to avoid undue stress on the mulch film. Choose a day that is not too windy or when the soil is to wet or to dry. It is important to take care in the preparation of the bed on minimize clumps, rocks and other sharp objects which might have a adverse affect on the mulch film.

One of the things that makes this mulch film special is that both the above ground degradable film A and the below ground degradable film B are formulated to degrade coincidentally so that the anchor function continues until the above ground film no longer requires anchoring. The mulch film then degrades into the soil with no harm to the soil.

The degrading of the mulch film provides several benefits to the growers, first it protects the environment by eliminating massive quantities of plastic that would otherwise lay in disposal sites for extended periods of times and second, the cost for pick up and disposal of an ordinary plastic film is eliminated.

The stages of the above ground degradable film A are that: first, there is transition period, second is the on-set of degradation and physical property loss, third there is embrittlement, fourth there is fragmentation, fifth there is miniaturization and sixth the film is visually gone. At this stage the average Mn and average Mw are typically below 500 Daltons. Transition Period is a period which the product exhibits features of normal plastic. This may be different for different crops but in one case it might be for about 100 days after application. Next is the onset of embrittlement, which commences at the end of the transition time. Then the film goes into the embrittlement stage, which can very in length but in one embodiment it might be 30 to 60 days. The film then goes into fragmentation. Fragmentation is marked by substantially all of the plastic having fragmented into brittle pieces with dimensions between several feet to several inches or smaller. During fragmentation the film loses elastic characteristics and changes crystallinity so that there is no sticking or adhering of the film fragments to the farming equipment when the field is plowed, disked, roto-tilled, or in other ways worked. Miniaturization then occurs at the end of the fragmentation stage when the mechanical action of plowing, tilling or discing adds to the breakdown of the embrittled film. At this stage all pieces of the film further fragment into miniature pieces between one inch and confetti sized pieces or smaller. Then after one or two years in the soil all the pieces are visually gone.

The above ground degradable film A FIG. 1, 12, can either be extruded in clear form or it might be colored. It can be colored so that a grower can visually identify where he has planted certain crops before they begin to grow or it can be colored to enhance certain properties. For example the film can be colored with carbon black to create a black film, which would capture infrared heat from sunlight and enhance growing conditions in colder climates. Likewise the above ground degradable film A can be colored white with the addition of titanium dioxide and or combinations with other oxides to co-synergize and provide further control of the rates of degradation, which would reflect light on hotter climates and help conserve water usage. Further additions of infrared absorbers with traditional pigments used in plastic film can be tailored to adjust the level of infrared heat stored in mulch films and green house film to increase crop growth rates and size and coloration of the resulting crops.

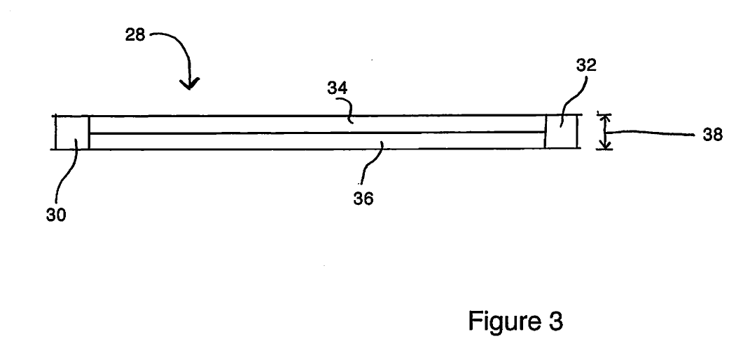

In one of the embodiments of the invention a mulch film 28, FIG. 3, two different above ground films can be extruded and laminated together 34, 36, along with the below ground films 30, 32. In this embodiment it is important that the film thickness 38 for both the above ground layers 34, 36 and the below ground layers 30, 32, are virtually the same so that when the mulch film 28 is wrapped into a roll form that it is still uniform. In one of the embodiments of the invention this would mean that one of the above ground layers 34 could contain colorants which would render the film white and the other above ground layer 36 could contain colorants which would render the film black. In this embodiment if the grower wants to retain heat he applies the roll with the black above ground layer 36 side up and the white above ground layer 34 down. If his growing conditions warrant more refection of light he applies the roll with the white above ground layer 34 side up and the black above ground layer 36 side down. In another embodiment of the invention one of the above ground layers could be clear and another colored or they could be colored other colors. It is also possible to configure these layers with additives that would condition the soil or repel insects or pests.

In another embodiment of the invention addition elements and compounds can be added to the plastic or natural resin, which would help nourish the soil once the film starts to decompose. Examples of these additives include the three primary macronutrients: nitrogen, phosphorous and potassium, as well as the three secondary macronutrients: calcium, sulfur and magnesium. In addition trace elements or micronutrients such as copper, iron, boron, chlorine, manganese, zinc, selenium and molybdenum. Ammonium based compounds such as anhydrous ammonium nitrate, ammonium phosphates and urea. One example of a compound that could be added is potash, which is a combination of potassium with chlorine. By adding combinations of these elements and compounds to the resin matrix the soil would be enriched by the decomposition of this mulch films.

In another embodiment of the invention addition compounds can be added to the plastic or natural resin, which would give the mulch film a natural repellant to insects and pest through the addition of an essential oil. These essential oils are volatile materials, which occur in certain plants and are recovered by an accepted procedure such that the nature and composition of the product is nearly as practicable and unchanged by such procedures. These oils have been extracted from 3000 plants of which 200 to 300 are commonly traded on the world markets. Essential oils or plant extracts are the compounds found in the leaves, stems and reproductive structures of the plant. Essential oils are aromatic volatile liquids distilled from shrubs, flowers, trees, roots, bushes and seeds. None are synthetic or hydrogenated but are highly oxygenated species of complex compositions. Essential oils are different from vegetable oils such as corn oil, peanut oil and olive oil. They are not greasy and do not clog the pores like many vegetable oils in the human arteries. An essential oil is an aromatic, volatile substance extracted by distillation or physical expression from a single botanical species. The resulting oil should have nothing added or removed. Examples of these essential oils include, but are not limited to cedarwood oil, neem oil, citronella oil, wintergreen oil, oil of wintergreen (methyl salicylate), eucalyptus oil, tea tree oil and combinations thereof. It should be noted that some of these oils may have more than one verity for example cedarwood oil comes as cedarwood oil cedrus atlantica, cedarwood oil cedrus deodara, cedarwood oil Chinese cupressus funebris franco, cedarwood oil Texas juniperus ashei Buchholz, cedarwood oil juniper juniperus recurva Buch-ham ex D. Don, cedarwood oil Virginian Juniperius Virginiana L. In addition Eucalyptus oil can be broken down into eucalyptus globules, citronelle eucalyptus citriodora, eucalyptus camaldulensis.

It should be noted that methyl salicylate, oil of wintergreen in the past was a natural product commonly distilled from the twigs of Sweet Birch and Eastern Teaberry. Today it is possible to synthesize methyl salicylate by esterifying salicylic acid with methanol.

The mulch film is comprised of two different films, which are bonded or brought together in two different ways either using co-extrusion technology or a unique laminator like structure. This mulch film brings the these two different types of films A and B together so that the film appears, feels and act as one film. The mulch film has no bump or change in diameter where the two types of film abut or adjoin. To produce this unique mulch film one can use from 2 to 6 extruders. This process also blends well to preserve the film technology using 2 to 6 extruders. The two or three film resins structures can be extruded into thin films by the cast-die process and joined together as the thin film exits the die.

### Examples

### Basic Formulation for Below Ground Film B

| Sample number F111009G | Percentages |
|---|---|
| Nucrel resin (Du-Pont) | 76.82 |
| Cobalt stearate concentrate (48%) | 6.89 |
| Citric Acid concentrate (10%) | 0.63 |
| Calcium Carbonate (40%) | 3.13 |
| Yellow Iron Oxide pigment concentrate (40%) | 12.53 |

By varying the composition of components 2, 3, 4, and 5, we can achieve various degrees of degradation under the soil.

### Formulations for the Above Ground Film A Containing Various Levels of Quenchers to Delay the Degradation Reaction

| Sample | FH | FI | FM | FO |
|---|---|---|---|---|
| LDPE | 3 lbs | 3 lbs | 3 lbs | 3 lbs |
| Green Concentrate | 8 grams | 8 grams | 8 grams | 8 grams |
| Cerium Concentrate | 40 grams | 40 grams | 40 grams | 40 grams |
| Cobalt Stearate | 40 grams | 40 grams | 40 grams | 40 grams |
| HA88UV Concentrate | 50 grams | | | |
| Zinc Oxide Concentrate | | 50 grams | | |
| Calcium Oxide Conc. | | | 50 grams | |
| PEPQ Concentrate | | | | 50 grams |

| Sample | FR | FS | FQ |
|---|---|---|---|
| LDPE | 3 lbs | 3 lbs | 3 lbs |
| Green Concentrate | 8 grams | 8 grams | 8 grams |
| Cerium Concentrate | 40 grams | 40 grams | 40 grams |
| Cobalt Stearate | 40 grams | 40 grams | 40 grams |
| Tin. 770 Concentrate | 50 grams | | |
| Tin. 944 Concentrate | | 50 grams | |
| BHT | | | 50 grams |

Notes:
The cerium and cobalt salt concentrates are 5% active and 95% LLDPE resin. The quencher concentrates HA88, Zn oxide, calcium oxide, PEPQ and tin 944 are 3.75% active. The above ground sample will also come in clear, black, and white colors depending on time and crop regiments.

### Below Ground Layer

| | | Compound |
|---|---|---|
| | 100 lbs. | Assignment Number |
| Nucrel 1202 HC resin | 76.82 | |
| CoSt₂ | 6.89 | PR112509A |
| Acid conc. (10%) | 0.63 | PR112509B |
| CaCo₃ conc. (40%) | 3.13 | PR112509C |
| Yellow oxide conc. (40%) | 12.53 | PR112509D |

### Above Ground Clear (Two Formulas)

| | |
|---|---|
| | Compound |
| 100 lbs. batch | Assigned Number |

Clear A (fast)

| | | |
|---|---|---|
| LDPE (West Lake) 808P | 79.9 | |
| LLDPE(exceed 1018) | 15.6 | |
| 480 C-D (2.90%) | 1.5 | PR010819B |
| Tin 770 D (3.75%) | 3.0 | PR010810A |

Clear B (slow)

| | | |
|---|---|---|
| LDPE (808P) | 78.25 | |
| LLDPE (Exceed 1018) | 14.75 | |
| 480 C-D (conc) (2.90%) | 1.0 | PR010810B |
| 770 (conc) (3.75%) | 6.0 | PR010810A |

Clear C (very slow)

| | | |
|---|---|---|
| LDPE (Westlake) (808P) | 76.5 | |
| LLDPE (Exceed 1018) | 16.0 | |
| 480 C-D (conc) conc 3.75 | 0.5 | PR010810B |
| 770-0 (conc) conc 3.75 | 7.0 | PR010810A |

Note:
480 C-D is a blend of 1:1 cerium stearate and cobalt stearate

### Above Ground Black (Three Formulas)

100 lb. Batch

Formula #1

| | |
|---|---|
| LDPE (808P) | 75.0 |
| LLDPE (exceed 1018) | 13.0 |
| 480C-D conc 2.9% | 2.0 |
| 770-D conc 3.75% | 4.0 |
| Tarquin Carbon Black conc. 50% | 6.0 |

Formula #2

| | |
|---|---|
| LDPE (808P) | 71.5 |
| LLDPE (exceed 1018) | 15.0 |
| 480 C-D conc 2.90% | 0.5 |
| 770 conc. conc 3.75% | 7.0 |
| Tarquin Carbon Black conc. 50% | 6.0 |

Formula #3

| | |
|---|---|
| LDPE (808P) | 71.0 |
| LLDPE (exceed 1018) | 13.0 |
| 480C-D Conc | 3.0 |
| 770 Conc. | 7.0 |
| Tarquin Carbon Black 50% | 6.0 |

### Above Ground (White Formulations)

100 lb. batch

Formula #1

| | |
|---|---|
| LDPE (808P) | 68 |
| LLDPE (exceed 1018) | 12 |
| 480 C-D (conc 2.90%) | 1.5 |
| 770-D (conc 3.75%) | 4.5 |
| White TiO₂ conc. (70% conc) | 6.0 |
| *CO/WG 300 conc. | 8.0 lbs |

Formula #2

| | |
|---|---|
| LDPE (808P) | 65.5 |
| LLDPE (exceed 1018) | 13.5 |
| 480 C-D conc 2.90% | 1.0 |
| 770-D conc 3.75%) | 6.0 |
| White TiO₂ conc. 70% conc | 6.0 |
| CO/WG 300 conc. 28% conc | 8.0 |

Formula #3

| | |
|---|---|
| LDPE (808P) | 64.0 |
| LLDPE (exceed 1018) | 13.5 |
| 480 C-D conc 2.90% | 0.5 |
| 770-D conc 3.75% | 8.0 |
| White TiO₂ conc (70% conc) | 6.0 |
| CO/WG 300 conc (28% conc) | 8.0 |

*CO/WG 300 Conc. containing:
70% Cedar Oil
70% Wintergreen
14.0% Dow Corning Silane 1184
72% Bisell porous resin 7153

What is claimed is:

1. A method for increase crop yield and weight per acre comprising the steps of:
providing a degradable mulch film comprised of a below ground degradable film (B) an above ground degradable film (A), film 13 being coextruded with film A and another film B to have a BAB structure where films said films B and said film A have a single layer feel;
film B being formed from a resin B selected from the group consisting essentially of: a plastic resin treated with an acid,
bio-resins that meets ASTM 6400 composting requirements or combinations thereof;
said plastic resin treated with an acid also comprising:
an additive that supplies a source of oxygen, and a metal stearate;
film A being formed from a plastic resin selected from the group of consisting of:
polyethylene, polypropylene, polybutylene terephthalate, polyethylene terephthalate, polycarbonate and combinations thereof;
an additive for aiding decomposition where said additive for aiding decomposition is a metal prodegradant; and
an additive to retard decomposition where said additive to retard decomposition is an additive selected from the group of:
UV stabilizer, metal oxides, primary antioxidants, secondary antioxidants and combinations thereof;
laying said degradable mulch film over a cleared field;
covering said below ground degradable film B with soil; and
allowing said degradable mulch film to degrade both above and below ground.

2. The method for increase crop yield and weight per acre according to claim 1 further comprising the step of:
providing said degradable mulch film in roll form.

3. The method for increase crop yield and weight per acre according to claim 2 where said above ground degradable film (A) is colored with a color selected from the group consisting of: black or white.

4. The method for increase crop yield and weight per acre according to claim 2 where said above ground degradable film (A) is provided as a two layer laminate with one layer being a black film and one layer being a white film.

5. The method for increase crop yield and weight per acre according to claim 1 where said plastic resin of film B is a resin selected from the group of consisting of:
polyethylene, polypropylene, polybutylene terephthalate, polyethylene terephthalate, polycarbonate, PLA, polycaprotone, mater-B and combinations thereof; where said acid treatment is selected from the group consisting of:
acrylic acid, maleic anhydride, vinyl acetate, eythyl acetate;
where said additive for aiding decomposition is a metal prodegradant;
where said additive that is a source of oxygen is an additive selected from the group of:
a pigment that contain oxygen, an oxidizer and combinations thereof.

6. The method for increase crop yield and weight per acre according to claim 1 where said plastic resin in film A has a molecular weight that differs by 5% or less to said resin in film B's molecular weight.

7. The method for increase crop yield and weight per acre according to claim 1 where a soil conditioning additive is added to a film selected from the group of film A, film B or combinations thereof;
said soil conditioning additive comprises a macronutrient selected from the group consisting essentially of: nitrogen, phosphorous, potassium and combinations thereof;
said soil conditioning additive comprises a micronutrients selected from the group consisting of: calcium, sulfur, magnesium copper, iron, boron, chlorine, manganese, zinc, selenium, molybdenum and combinations thereof.

8. The method for increase crop yield and weight per acre according to claim 1 where an essential oil is added to a film selected from the group of film A, film B or combinations thereof;
said essential oil is selected from the group of: an extract from a single botanical species or synthetic methyl salicylate.

9. A method of manufacturing a degradable mulch film comprising the steps of:
providing a plastic resin A having from 99.98% to 90% by weight of said
plastic resin A selected from the group of consisting of:
polyethylene, polypropylene, polybutylene terephthalate, polyethylene terephthalate, polycarbonate and combinations thereof;
an additive for aiding decomposition from 0.02% to 5% by weight of said plastic resin A where said additive for aiding decomposition is a metal prodegradant; and
an additive to retard decomposition from 0.02% to 5% by weight of said plastic resin A where said additive to retard decomposition is an additive selected from the group of:
UV stabilizer, metal oxides, primary antioxidants, secondary antioxidants and combinations thereof;
resin A having a molecular weight;
providing a resin B selected from the group consisting essentially of: a
plastic resin treated with an acid, bio-resins that meets ASTM 6400 composting requirements or combinations thereof;
said plastic rein treated with an acid also comprising an additive that supplies a source of oxygen, and a metal stearate;
resin B having a molecular weight that differs from said molecular weight of resin A by 5% or less;
co-extruding resin A with resin B;
blow-molding resins A and resin B into a bubble; and
slitting said bubble to create a plastic film having a BAB composition.

10. The method of manufacturing a degradable mulch film according to claim 9 further comprising the steps of:
having from 98.98% to 55% by weight of said plastic resin treated with an acid selected from the group of consisting of:
polyethylene, polypropylene, polybutylene terephthalate, polyethylene terephthalate, polycarbonate and combinations thereof;
where said acid is selected from the group consisting of:
acrylic acid, maleic anhydride, vinyl acetate, eythyl acetate, acetic acid and combinations thereof;
having from 0.02% to 5% by weight of said additive for aiding decomposition is a metal prodegradant;
having from 1% to 40% by weight of said additive that is a source of oxygen is an additive selected from the group of:
a pigment that contain oxygen, an oxidizer and combinations thereof.

11. The method of manufacturing a degradable mulch film according to claim 9 further comprising the step of:
rolling said plastic film into a roll.

12. The method of manufacturing a degradable mulch film according to claim 9 further comprising the step of:
adding a soil conditioning additive to a resin selected from the group consisting of: resin A, resin B or combinations thereof;
where said soil conditioning additive comprises one or more macronutrients selected from the group consisting essentially of: nitrogen, phosphorous, potassium and combinations thereof;
as well one or more macronutrients or micro nutrients selected from the group consisting of: calcium, sulfur, magnesium copper, iron, boron, chlorine, manganese, zinc, selenium, molybdenum and combinations thereof.

13. The method of manufacturing a degradable mulch film according to claim 9 further comprising the step of:
adding a pigment or dye to said resin A.

14. The method of manufacturing a degradable mulch film according to claim 9 further comprising the step of:
adding an essential oil where said essential oil is selected from the group of: an extract from a single botanical species or synthetic methyl salicylate.

15. A degradable mulch film comprising:
a film A made of from 99.98% to 90% by weight of a plastic resin A selected from the group of consisting
of: polyethylene, polypropylene, polybutylene terephthalate, polyethylene terephthalate, polycarbonate and combinations thereof;
from 0.02 to 5% of an additive for aiding decomposition where said additive for aiding
decomposition is a metal prodegradant;
from 0.02 to 5% of an additive to retard decomposition where said additive to retard
decomposition is an additive selected from the group of: UV stabilizer, metal oxides, primary antioxidants, secondary antioxidants and combinations thereof;
resin A having a molecular weight;
a film B made of a resin B being a resin selected from the group consisting of: a plastic resin treated with an acid, an additive that supplies a source of
oxygen, and a metal stearate; a bio-resins that meets ASTM 6400 composting requirements or combinations thereof;
resin B having a molecular weight that differs by 5% or less to said molecular weight of resin A; and
said film B being coextruded with said film A and another film B to have a BAB structure where said films B and said film A have a single layer feel.

16. The degradable mulch film according to claim 15 where said plastic resin of film B made of from 98.98% to 55% by weight of a resin selected from the group of consisting of:
polyethylene, polypropylene, polybutylene terephthalate, polyethylene terephthalate, polycarbonate, and combinations thereof;
where said acid treatment is selected from the group consisting of:
acrylic acid, maleic anhydride, vinyl acetate, eythyl acetate, acetic acid and combinations thereof;
where said additive for aiding decomposition is from 0.02 to 5% by weight of a metal prodegradant;
where said additive that is a source of oxygen is from 1% to 40% by weight an additive selected from the group of:
a pigment that contain oxygen, an oxidizer and combinations thereof.

17. The degradable mulch film according to claim 15 further comprising a colorant selected from the group consisting of: pigments, dyes and combinations thereof.

18. The degradable mulch film according to claim 15 further comprising a soil conditioning additive where said soil conditioning additive comprises one or more macronutrients selected from the group consisting essentially of: nitrogen, phosphorous, potassium and combinations thereof;
one or more macronutrients or micro nutrients selected from the group consisting of: calcium, sulfur, magnesium copper, iron, boron, chlorine, manganese, zinc, selenium, molybdenum and combinations thereof.

19. The degradable mulch film according to claim 15 further comprising an essential oil where said essential oil is selected from the group of: an extract from a single botanical species or synthetic methyl salicylate.

20. The degradable mulch film according to claim 15 made by a process selected from the processes of: co-extruding or laminating.
